(19) United States
(12) Patent Application Publication
(10) Pub. No.: US 2016/0194205 A1
(43) Pub. Date: Jul. 7, 2016

(54) HYBRID GRAPHENE MATERIALS AND METHODS OF FABRICATION

(71) Applicant: Advanced Green Innovations, LLC, Chandler, AZ (US)

(72) Inventor: Deepak Varshney, Tempe, AZ (US)

(21) Appl. No.: 15/068,269

(22) Filed: Mar. 11, 2016

Related U.S. Application Data
(63) Continuation-in-part of application No. PCT/US15/33632, filed on Jun. 2, 2015.
(60) Provisional application No. 62/005,977, filed on May 30, 2014.

(51) Int. Cl. C01B 31/04; B29C 41/46; B29C 41/02; B05D 3/02; B29C 67/20

(52) U.S. Cl. CPC C01B 31/0446; B05D 3/0272; B29C 67/202; B29C 41/02; B29C 41/46; B29K 2105/0058

(57) ABSTRACT

Methods for fabricating graphene materials may coat a hydrocarbon precursor onto a metal substrate and heat the coated metal substrate to a first temperature. Methods may then maintain the first temperature of the coated metal substrate for a duration which dissociates the hydrocarbon precursor into carbon on the metal substrate, and cool the coated metal substrate to a second temperature that is lower than the first temperature. Heating the coated metal substrate may dissociate the hydrocarbon precursor and cooling the coated metal substrate may allow the dissociated hydrocarbon to arrange itself into graphene on the metal substrate.

### CROSS-REFERENCE TO RELATED APPLICATION

This application is a Continuation In Part application of PCT international application No. PCT/US2015/033632, filed on Jun. 2, 2015, titled Hybrid Graphene Materials and Methods of Fabrication, which claims priority to U.S. Provisional Application No. 62/005,977, filed on May 30, 2014, titled Hybrid Graphene Materials and Methods of Fabrication, both are incorporated herein by reference in their entirety.

### TECHNICAL FIELD

This patent document relates to systems, devices, and processes that use nanoscale fabrication technologies.

### BACKGROUND

Graphene is an allotrope of carbon which takes the form of an ordered hexagonal lattice of carbon atoms with sp²-hybridized bonds. The hexagonal lattice may present as a single layer (with a thickness of one carbon atom) or multiple sheets ordered three-dimensionally. It is the fundamental structural element for other carbon allotropes, including graphite and carbon nanotubes. The former consists of randomly stacked graphene layers while the latter is essentially a section of graphene rolled to form a hollow cylinder. Graphene has many singular and/or extraordinary properties. Its electrical and thermal conductivities are among the highest of all materials making it an excellent candidate for (nano) electronics applications. Graphene's mechanical strength is significantly greater than steel, offering great potential for structural applications given a suitable process for its large-scale, efficient fabrication.

Nanotechnology provides techniques or processes for fabricating structures, devices, and systems with features at a molecular or atomic scale, e.g., structures in a range of about one to hundreds of nanometers in some applications. For example, nano-scale devices can be configured to include sizes similar to some large molecules, e.g., biomolecules such as enzymes. Nano-sized materials used to create a nanostructure, nanodevice, or a nanosystem can exhibit various unique properties, including optical properties, that are not present in the same materials at larger dimensions. Such unique properties can be exploited for a wide range of applications.

### SUMMARY

Graphene materials and methods to produce the graphene materials are disclosed, including systems and devices implementing the methods to fabricate graphene materials.

The subject matter described herein may be implemented to provide one or more of the following features. For example, the disclosed technology includes a method of fabricating graphene in 2D and 3D structures, including graphene sheets (2D structure), graphene foam (3D structures), graphene-hybrid nanostructures, and doped graphene. In some embodiments, the disclosed fabrication methods can include using a precursor comprising semi-solid saturated hydrocarbons, or a mixture of different hydrocarbons, for the growth of graphene on 2D substrates and/or 3D metal substrates, a mixture of hydrocarbons together with dopants for doped graphene, and/or a mixture of hydrocarbons together with semiconducting nanoparticles, and/or metal nanoparticles. Using thermal decomposition and other processes, graphene and graphene-hybrid nanostructures may be fabricated.

In some embodiments, the substrate may include pre-annealed or un-annealed nickel, copper, stainless steels, or aluminum foil, rectangular or rolled nickel, copper, or stainless steels foam, silicon, and other metals. Too, the substrate may be a non-metal that includes a layer of metal upon which the precursor is coated. In some embodiments, the precursor may include n-tetracosane and/or n-octacosane, paraffin, paraffin melt, candle wax, white petrolatum, or other hydrocarbons and semi-solid saturated hydrocarbons. The precursor may be used as a seeding mixture together with any dopant or metal nanoparticles for the fabrication of the graphene nanoparticles, the graphene-hybrid nanostructures, and/or nitrogen-, boron-, sulfur-containing materials or other dopants.

One embodiment described herein may include a method for fabricating graphene materials. The method may coat a semi-solid non-volatile hydrocarbon precursor onto a metal substrate and then heat the coated metal substrate to a first temperature. The method may then maintain the first temperature of the coated metal substrate for a duration which dissociates the semi-solid hydrocarbon precursor into carbon on the metal substrate, and cool the coated metal substrate to a second temperature that is lower than the first temperature. Heating the coated metal substrate may dissociate the semi-solid hydrocarbon precursor and cooling the coated metal substrate may allow the dissociated hydrocarbon to arrange itself into graphene on the metal substrate.

Another embodiment described herein may include a method for producing porous graphene. The method may include coating a non-volatile semi-solid hydrocarbon-nanoparticle mixture onto a metal substrate. The hydrocarbon-nanoparticle mixture may include a semi-solid saturated hydrocarbon and nanoparticles. The nanoparticles may include at least one of copper, nickel, activated carbon, silicon, zinc oxide, tin oxide, or manganese oxide. The method may also heat the semi-solid hydrocarbon-nanoparticle mixture coated metal substrate to substantially at least 450° C. and maintain a temperature of the hydrocarbon-nanoparticle mixture coated metal substrate at substantially at least 450° C. Maintaining the temperature at substantially at least 450° C. may dissociate the hydrocarbon-nanoparticle mixture on the surface of the metal substrate into carbon and the nanoparticles. The method may then cool the heated hydrocarbon-nanoparticle mixture coated metal substrate by substantially at least 20° C. per minute to reach 200° C. or less. The cooling may allow the carbon to precipitate out at the surface of the metal substrate or otherwise arrange itself into graphene together with the nanoparticles. The method may also coat a polymer on the graphene and nanoparticles and then disperse the metal substrate and nanoparticles.

### BRIEF DESCRIPTION OF THE DRAWINGS

The figures described below depict various aspects of the methods, systems, and devices disclosed herein. It should be understood that each figure depicts an embodiment of a particular aspect of the disclosed methods, systems, and devices, and that each of the figures is intended to accord with a possible embodiment thereof. Further, wherever possible, the following description refers to the reference numerals included in the following figures, in which features depicted in multiple figures are designated with consistent reference numerals.

FIG. 1 shows an illustrative process diagram of an exemplary graphene synthesis method;

FIG. 2 shows a further illustrative process diagram of the exemplary graphene synthesis method;

FIG. 3 show exemplary cooling rate effects of graphene synthesis methods;

FIG. 4 shows a still further illustrative process diagram of an exemplary graphene synthesis method;

FIG. 5 shows an illustrative process diagram of an exemplary graphene synthesis method to produce tubular graphene membranes;

FIGS. 6A, 6B, 6C, and 6D show exemplary methods for fabricating carbon nanotube structures; and

FIGS. 7A1, 7A2, 7A3, 7B1, 7B2, 7B3, 7C1, 7C2, 7C3, 7C4, 7D1, 7D2, 7D3, 7E1, 7E2, 7E3, 7F1, 7F2, 7G1, 7G2, and 7G3 show results of working examples of the methods described herein.

### DETAILED DESCRIPTION

Techniques, systems, and devices are described for fabricating graphene materials and graphene-hybrid nanostructured materials.

In some aspects, the disclosed technology provides methods of fabricating graphene 2D and 3D structures, doped graphene 2D and 3D structures, and graphene incorporated with metal/semiconducting nanoparticles using semi-solid saturated hydrocarbons or their mixtures, among other materials. In some implementations, metal/semiconducting nanoparticles embedded graphene films can be fabricated and further used as substrates or templates for the growth of various kind of nanomaterials and combinations thereof, e.g., resulting in graphene-nanomaterial heterostructure. In some implementations, for example, dopant utilized in the fabrication methods can include lithium, beryllium, boron, nitrogen, phosphorous, or their compounds. In some embodiments, the disclosed methods include single-step synthesis processes.

In some aspects, the disclosed technology provides methods of fabricating the nanoparticle-incorporated graphene 2D and 3D structures (graphene-nanomaterial incorporated structure), e.g., including, but not limited to, Si incorporated graphene, Cu incorporated graphene, and Au incorporated graphene, among others.

In some aspects, the disclosed technology provides methods of fabricating graphene hybrid 2D and 3D structures, e.g., such as carbon nanotube-graphene, boron nitride nanotube-graphene, semiconductor oxide nanostructures, carbon nanofibers, and their combination. The disclosed technology provides methods of fabricating graphene-nanomaterial heterostructure, e.g., such as graphene-carbon nanotube heterostructure, and graphene-semiconductor oxide nanostructure heterostructure (e.g., such as graphene-SnO₂ nanorods, graphene-Si nanowires heterostructure).

In some aspects, the disclosed technology provides methods of fabricating doped graphene films using semi-solid saturated hydrocarbon mixture and at least one dopant.

Various and exemplary aspects of the present technology include, but are not limited to doped graphene, nanoparticle incorporated graphene, graphene-nanostructure hybrids, doped graphene-nanostructure hybrids that can be used for various applications like fuel cell, super capacitors, catalyst support, photovoltaic devices, chemical sensors and gas separable membranes.

Exemplary applications of the present technology include, but are not limited to: hydrogen storage; photovoltaic devices; fuel cells; super capacitors; gas separable membranes; high temperature electronics; Li ion batteries; catalyst support; and chemical sensors; among others.

The disclosed technology is capable of being implemented to provide the following. For example, the produced graphene material can be fabricated to have a vast surface area. For example, the disclosed fabrication methods can allow for easy fabrication of doped graphene. For example, the disclosed fabrication methods can allow for easy fabrication of metal nanoparticle incorporated graphene structures. For example, the disclosed fabrication methods can allow for single step synthesis.

Conventional fabrication methods are incapable of producing different graphene-hybrid nanostructures in a single fabrication step. In contrast, the disclosed technology includes methods of fabrication of graphene-hybrid nanostructures in a single synthesis step or process.

The methods described herein are different from past processes to produce graphene and provide various advantages. For example, the methods described herein employ an environment free of gaseous Hydrocarbon precursors for the production of graphene structures where no hazardous or poisonous gasses are used. Further, growth time is reduced and, beyond a furnace, no specialized equipment is needed providing a cost-effective, environmentally friendly method for producing graphene structures. Using the methods described herein, a wide range of graphene and graphene hybrid materials and structures may be produced. While not an exhaustive listing, materials such as 2D graphene sheets, 3D graphene foam, graphene hybrid materials and structures employing various other materials (e.g., nanoparticles of silicon, copper, iron, gold having a size of 100 nm or about 100 nm or less), activated carbon (e.g., activated carbon nanopowder having specific surface area of about 1000 m²/gm), graphene-carbon nanotube hybrid structures), and doped graphene materials such as nitrogen-doped graphene. Other materials and structures may be fabricated employing the methods herein described including graphene platinum, palladium, or manganese hybrid materials and structures, layered structures of graphene nanotubes, silicon nanowires, graphene-quantum dots hybrid structures, and graphene-metal oxide semiconductor (MoS) hybrid structures. Still other materials and structures may be fabricated employing the methods herein described including graphene-gold nanoparticles hybrid on nickel foam and foils, graphene-iron nanoparticles hybrid on nickel foam and foils, graphene-nickel nanoparticles hybrid on nickel foam and foils, a sheet, a deposited layer, nitrogen-doped graphene-porous silicon nanoparticles hybrid, nitrogen-doped graphene-iron nanoparticles hybrid on nickel foam, graphene copper/zinc oxide hybrid on nickel foam, graphene-R₁₂₀ (Cu/ZnO/Al₂O₃) hybrid on nickel foam and foils, graphene-CNT hybrid structure on nickel foam, and graphene-coated stainless steels wire.

In one exemplary embodiment, a method to fabricate graphene can include the following preparation procedures in a single process. The single-step synthesis method includes a heating-cooling process of a semi-solid non-volatile hydrocarbon or their mixtures that are coated on a substrate before being placed in a furnace for heating and processing into graphene. For example, a semi-solid non-volatile saturated hydrocarbon having single bonds and containing the maximum number of hydrogen atoms for each carbon atom may be used. White petrolatum (petroleum jelly), paraffin, paraffin melt, and other materials may be used as an inexpensive precursor. In some embodiments, a precursor containing at least twenty carbon atoms is used.

Exemplary preparation procedures to implement the single-step synthesis method can include coating the semi-solid hydrocarbon or other precursor having at least twenty carbon atoms on the (2D or 3D) metal substrates (e.g., Ni, Cu etc.) and subjecting the coated substrate to a heating-cooling thermal process. In some implementations, the exemplary thermal process can include putting the coated-metal substrate (e.g., hydrocarbon coated Ni foil) in a tube furnace and preparing the environment for graphene growth (e.g., pumping down the furnace to a base pressure to 5 mTorr or less and purging the environment) and heating the furnace containing the semi-solid hydrocarbon-coated substrate to an elevated temperature. The elevated temperature may be high enough to dissociate the semi-solid non-volatile, saturated hydrocarbon. In some embodiments, the coated substrate may reach substantially at least 450° C. In some implementations, the exemplary heating-cooling process can include, at the elevated temperature (at least 450° C.), providing a non-reactive gas (e.g., N₂ and/or Ar) to maintain the pressure to an increased pressure from the base pressure (e.g., substantially at least 10 mTorr) for a time duration, depending on the type of substrate used. In some embodiments, the temperature for disassociating the carbon from the semi-solid non-volatile hydrocarbon is substantially at least 15 sec. In some implementations, after the desired time required for growth (at least 15 sec.), the exemplary heating-cooling thermal process can include lowering the furnace temperature to a second elevated temperature at a particular cooling rate for the growth of graphene. In some embodiments, the first elevated temperature is lowered to at least 700° C. at a cooling rate of 20° C./min., and then to about 200° C. at a cooling rate ranging between 20-100° C./min.

In another exemplary embodiment, a method to fabricate nitrogen-doped graphene can include the following preparation procedures in a single process. This single-step synthesis method includes a heating-cooling thermal process of a hydrocarbon-nitrogenous compound mixture coated on a metal substrate. Exemplary preparation procedures to implement the single-step synthesis method can include providing the 2D or 3D substrates (e.g., Ni, Cu, stainless steels, etc.); providing a semi-solid, non-volatile, saturated hydrocarbon or mixtures thereof (e.g., which can be configured to include tetracosane and octacosane melt or materials such as paraffin and petrolatum); and adding at least one chemical compound including nitrogen as one of the elements (nitrogenous compound) to this mixture, e.g., such as pyridine, phthalocyanine, or other compound. Exemplary preparation procedures to implement the single-step synthesis method can include coating the semi-solid hydrocarbon-nitrogenous compound mixture on the (2D or 3D) metal substrate (e.g. Ni, Cu, stainless steels). In some implementations, the exemplary heating-cooling thermal process can include putting the coated-metal substrate (e.g., hydrocarbon coated Ni foil) in a tube furnace, and preparing the furnace by pumping down the furnace to the base pressure (at least 5 mTorr) and heating the furnace to the elevated temperature (at least 450° C.). In some implementations, the exemplary heating-cooling process can include, at the elevated temperature (at least 450° C.), providing a non-reactive gas (e.g., N₂ and/or Ar, etc.) to maintain the pressure to an increased pressure from the base (e.g., at least 10 mTorr) for a time duration (e.g., at least 15 sec). In some implementations, after the desired time required for growth (e.g., at least 15 sec.), the exemplary heating-cooling thermal process can include lowering the furnace temperature to a second elevated temperature (at least 700° C.) at a particular cooling rate (at least 20° C./min) for the growth of nitrogen-doped graphene.

In another exemplary embodiment, a method to fabricate metal or semiconducting nanoparticle-incorporated graphene can include the following preparation procedures in a single process. This single-step synthesis method includes a heating-cooling process of a semi-solid, non-volatile, saturated hydrocarbon and metal, metalloid, and/or semiconductor nanoparticle-mixture coated on a substrate. Exemplary preparation procedures to implement the single-step synthesis method can include providing the 2D or 3D metal substrate (e.g., Ni, Cu, stainless steels, etc.); providing a semi-solid, non-volatile, saturated hydrocarbon or other mixture (e.g., which can be configured to include tetracosane and octacosane melt); and adding metal, metalloid, and/or semiconductor nanoparticles to this mixture. For example, the metal nanoparticles can include nickel, copper, iron, gold, silver, platinum, palladium, and/or cobalt, iridium, rhodium, osmium, and ruthenium among other metal nanoparticles; and, for example, the semiconductor nanoparticles can include silicon, zinc oxide, tin oxide, and/or manganese oxide, among other semiconductor nanoparticles. Exemplary preparation procedures to implement the single-step synthesis method can include coating the semi-solid hydrocarbon-nanoparticle mixture on the metal substrate (e.g., Ni, Cu, stainless steels). In some implementations, the exemplary heating-cooling process can include putting the coated-metal substrate (e.g., Ni, Cu, stainless steels) in a tube furnace, and pumping down the furnace to the base pressure (at least 5 mTorr) and heating the furnace to an elevated temperature (at least 450° C.). In some implementations, the exemplary heating-cooling process can include, at the elevated temperature (at least 450° C.), providing a gas (e.g., N₂ and/or Ar) to maintain the pressure to an increased pressure from the base (at least 10 mTorr) for a time duration, at least 15 sec. In some implementations, after the desired time required for growth (at least 15 sec.), the exemplary heating-cooling process can include lowering the furnace temperature to a second elevated temperature at a particular cooling rate for the growth of metal or semiconducting nanoparticle-incorporated graphene. In some embodiments, the elevated temperature may be reduced to 700° C. at a cooling rate of about 20° C./minute, and then to about 200° C. at a cooling rate ranging between 20-100° C./min.

In another exemplary embodiment, a method to fabricate metal or semiconducting nanoparticle-incorporated and nitrogen-doped graphene can include the following preparation procedures in a single process. This single-step synthesis method includes a heating-cooling thermal process of a hydrocarbon (e.g., a semi-solid saturated hydrocarbon), a metal, metalloid, and/or semiconductor nanoparticle, and nitrogenous compound-mixture coated on a substrate. Exemplary preparation procedures to implement the single-step synthesis method can include providing the 2D or 3D metal substrates (e.g., Ni, Cu, stainless steels); preparing a hydrocarbon (e.g., a semi-solid saturated hydrocarbon or other mixture which can be configured to include tetracosane and octacosane melt); adding at least one chemical compound including nitrogen as one of the elements (nitrogenous compound) to this mixture (e.g., pyridine, phthalocyanine, pyrazole, etc.); and adding metal, metalloid, and/or semiconductor nanoparticles to this mixture. Exemplary preparation procedures to implement the single-step synthesis method can include coating the semi-solid hydrocarbon-nanoparticle-nitrogenous compound mixture on the 2D or 3D metal substrate (e.g., Ni, Cu, stainless steels foil). In some implementations, the exemplary heating-cooling process can include putting the coated-metal substrate (e.g., semi-solid hydrocarbon coated Ni, Cu, stainless steels) in a tube furnace, and pumping down the furnace to the base pressure (at least 5 mTorr) and heating the furnace to an elevated temperature (at least 450° C.). In some implementations, the exemplary heating-cooling process can include, at the elevated temperature (at least 450° C.), providing a gas (e.g., N₂ and/or Ar) to maintain the pressure to an increased pressure from the base (at least 10 mTorr) for a time duration, at least 15 sec. In some implementations, after the desired time required for growth (e.g., at least 15 sec.), the exemplary heating-cooling process can include lowering the furnace temperature to a second elevated temperature at a particular cooling rate for the growth of metal or semiconducting nanoparticle-incorporated and nitrogen-doped graphene. In some embodiments, the elevated temperature may be reduced to at least 700° C. at a rate of about 20° C./min., and then to about 200° C. at a rate ranging from about 20-100° C./min.

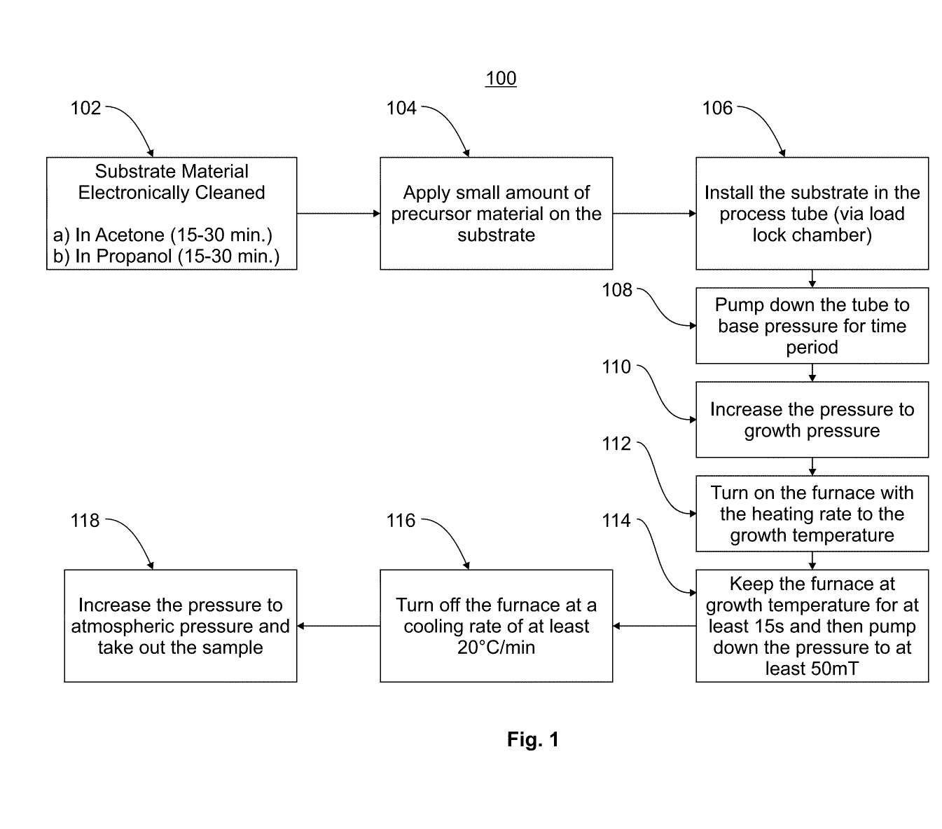

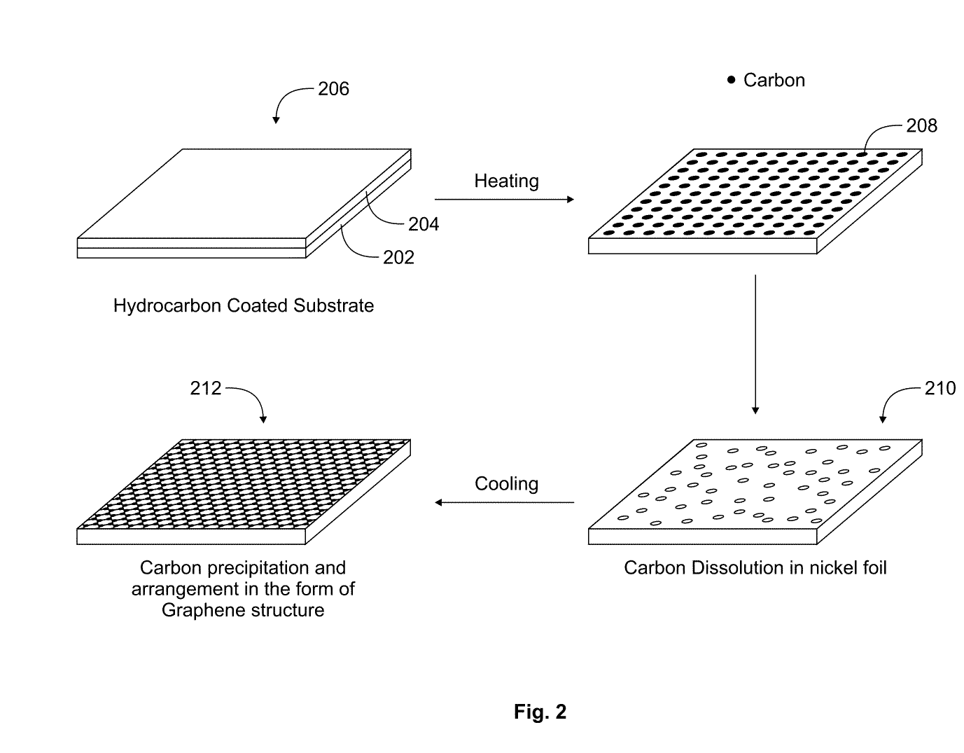

FIG. 1 shows an illustrative process diagram of an exemplary graphene synthesis method 100 and FIG. 2 illustrates fabrication of graphene using the method 100 of FIG. 1. At step 102 (FIG. 1), a substrate material 202 (FIG. 2) may be cleaned. In some embodiments, cleaning may include an ultrasonic process lasting fifteen to thirty minutes using acetone, propanol, or other agent. In other embodiments, cleaning may include electro-polishing or another chemical cleaning method. At step 104, a semi-solid hydrocarbon precursor 204 (e.g., a semi-solid non-volatile, saturated hydrocarbon or other mixture) may be applied to the substrate material 202. The coating of the coated substrate 206 may comprise a paraffin melt, petrolatum, or other semi-solid, non-volatile, saturated hydrocarbon precursor 204 coated on a nickel or copper foil or foam, a sheet, and a deposited layer or any other of the substrates as herein described. The coated substrate 206 may be heated in a furnace. In some embodiments, the coated substrate 206 may be placed in a process tube of a tube furnace at step 106. At step 108, a pressure within the process tube within the tube furnace may be reduced. In some embodiments, the pressure may be reduced to a base pressure for a period of time to prepare the furnace and coated substrate 206 for graphene growth. The base pressure may include a pressure of less than 50 mTorr and the time period may include at least 15 minutes. In some embodiments, the base pressure includes a pressure of 5 mTorr or less. At step 110, the pressure within the process tube may be increased to a growth pressure. In some embodiments, the growth pressure is at least 10 mTorr. At step 112, the tube furnace may heat the process tube and the coated substrate 206 at a particular rate to cause the carbon to dissociate from the precursor. In some embodiments, the tube furnace may heat the coated substrate 206 to at least 450° C. at a heating rate of at least 20° C. per minute and cause the semi-solid hydrocarbon precursor 204 to dissociate on the substrate 202 to form carbon 208. In other embodiments, the furnace may be heated to between about 800° C. and about 1000° C. at a heating rate of about 20° C. per minute. For example, the temperature of the furnace may be increased to a higher temperature (at least 450° C. or about 800° C. to about 1000° C.), which results in the dissociation 106 of the carbon precursor into carbon at high temperature on the substrate surface 104. At step 114, the temperature of the furnace may be maintained for a duration. In some embodiments, the duration includes a time of at least 15 seconds to about 38 minutes or until the carbon 208 is dissociated on the metal substrate. At step 116, the temperature of the coated metal substrate is reduced by cooling at a cooling rate to a desired temperature. In some embodiments, the cooling rate includes a rate of at least 20° C. per minute and the desired temperature includes 200° C. or less. On cooling, carbon precipitates out at the surface of the catalyst and arranges in hexagonal structures 212 (graphene). At step 118, once the furnace reaches the desired temperature, the pressure of the furnace may be increased to atmospheric in order to remove the sample.

In some embodiments, the process described above and in association with any of the other forms of graphene and graphene-hybrid materials described herein may employ a series of steps within a furnace that each include a time, temperature, and pressure. For example, over a period of about 36 minutes, the coated substrate 206 may be heated from 25° C. or about 25° C. to 1000° C. or about 1000° C. at a pressure of about 500 mTorr or less. The coated precursor may then be held at about 1000° C. for about 30 minutes at the 500 mTorr or less pressure. Over a period of about 12 minutes, the coated precursor 206 may then be cooled to about 750° C. and the pressure changed to about 50 mTorr. Then, over a period of about 30 minutes, the coated substrate may be “flash cooled” to about 200° C. at the pressure of about 50 mTorr. In further embodiments, the processes described herein may occur at atmospheric pressure.

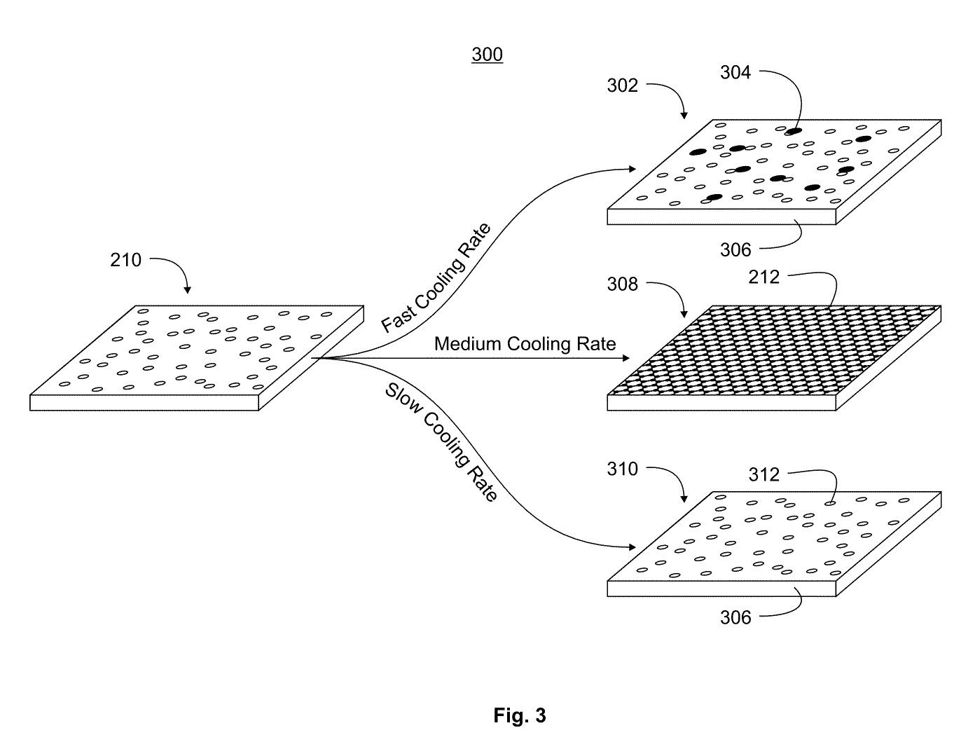

FIG. 3 shows an illustrative process diagram of exemplary cooling rate effects 300 of the graphene fabrication methods described herein (e.g., step 116 of the method 100). At a fast cooling rate 302, where the cooling rate is greater than about 100° C./min, for example, carbon atoms 304 that dissociate in the substrate 306 may not get enough time to precipitate out from the surface as a result of fast cooling, and only few carbon atoms may precipitate out from the substrate surface, which may not be enough to form a graphene structure 212. At a medium cooling rate 308, where the cooling rate which is in the range of about 20-100° C./min, the carbon atoms that dissociate in the substrate due to high temperature (e.g., at steps 112 and 114 of method 100) may receive enough time to precipitate out from the surface and arrange themselves in the form of graphene 212. At a slow cooling rate 310, where the cooling rate which is slower than 20° C./min, the carbon atoms 312 that dissociate in the exemplary Nickel substrate may receive enough time to arrange themselves in the Nickel, but may not precipitate out of the surface. As described herein, the cooling rate to form graphene is in the range of about 20-100° C./min.

Other exemplary graphene material fabrication techniques following the methods described herein may follow the same growth mechanism as generally described by the method 100. For example, the method 100 of FIG. 1 may be followed in the growth of various engineered graphene materials including nitrogen-doped graphene, metal/semiconducting nanoparticle-incorporated graphene, and/or metal/semiconducting nanoparticle-incorporated and nitrogen-doped graphene, and other graphene-nanostructure hybrids.

In some implementations of the disclosed methods, for example, the substrate 202, 306 can include copper foil, which can provide further uniformity in the formation of graphene layers. In further implementations, functionalization of the produced graphene or graphene-hybrid materials can be performed, and various activation processes can be included and implemented to activate the fabricated structure to increase the specific surface area required for certain exemplary applications.

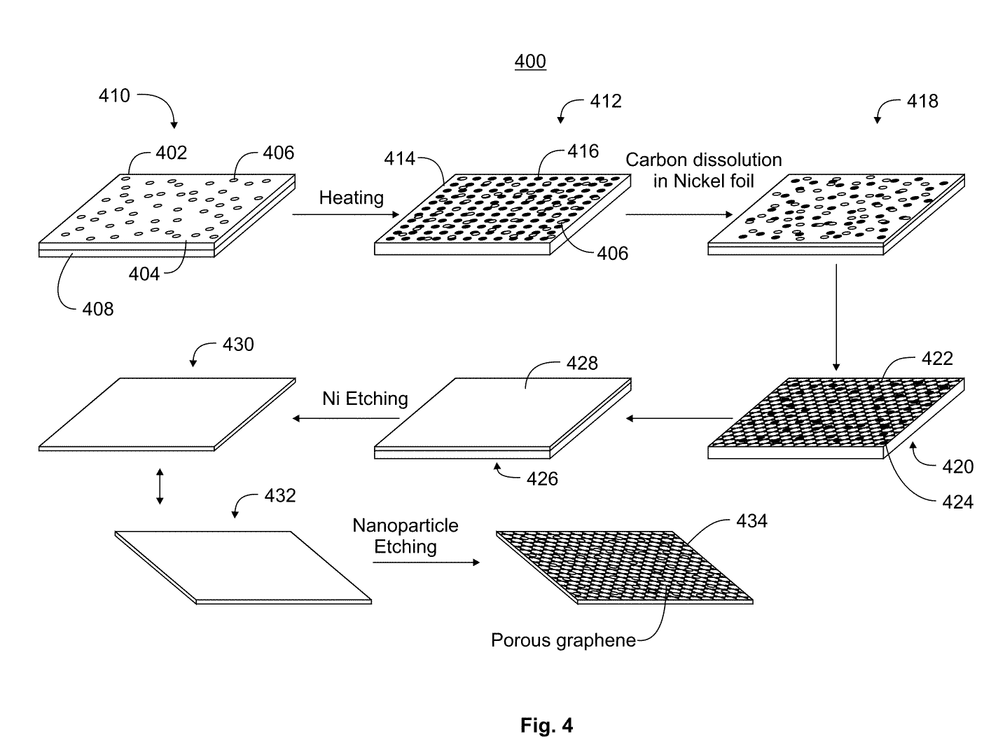

FIG. 4 shows an illustrative process diagram of an exemplary graphene synthesis method 400 to produce graphene which may be employed as gas separable membranes. Implementations of the exemplary method 400 can be used to fabricate porous graphene using exemplary nanoparticle-incorporated graphene, e.g., which can be produced using the method 100 of FIG. 1. As shown in FIG. 4, the method 400 includes coating a semi-solid hydrocarbon-nanoparticle mixture 402 on a substrate or catalyst 408. The semi-solid hydrocarbon mixture may include a precursor of saturated hydrocarbons 404 and metal nanoparticles 406 such as copper, nickel, etc. nanoparticles on the metal substrate 408) at 410. At 412, the semi-solid hydrocarbon-nanoparticle coated substrate may be placed in a furnace (e.g., such as tube furnace). In the furnace, the temperature of the mixture 402 and substrate 404 may be increased to a higher temperature (e.g., at least 450° C.) leaving carbon 416 and metal nanoparticles 406 on the substrate 408. Further, at the higher temperature, the semi-solid saturated hydrocarbon carbon precursor 404 may be dissociated on the substrate surface, e.g., leaving the metal nanoparticles 406 at the surface at 418. In some implementations, the temperature of the furnace may be maintained for a desired duration to cause carbon dissolution into the substrate 408. At 420, the temperature of the furnace may be reduced by cooling at a desired cooling rate to a desired temperature. In some embodiments, the cooling rate is between 20-100° C. per minute. On cooling, carbon precipitates out at the surface of the catalyst 404 and arranges themselves in hexagonal structures (graphene 422) together with metal nanoparticle incorporation 424.

At 426, the method 400 may coat a thin layer of polymer material 428 on the graphene and nanoparticle material. In some embodiments, the polymer includes Poly (methyl methacrylate) or PMMA. The polymer may be spin coated on the material to support the graphene. In other embodiments, the polymer may be drop cast and baked on the graphene. Further, the polymer may be treated, e.g., cleaned in hot acetone for a period of time, before using to coat the graphene. Likewise, the graphene may be treated prior to coating by thermal annealing within or outside of a vacuum. At 430 and 432, the method 400 may disperse the polymer-graphene/nanoparticle substrate (e.g., the exemplary PMMA-graphene-Ni or Cu substrate) in a chemical solution and at 434 may etch the substrate and the metal nanoparticles. A result of this etching is porous graphene 434.

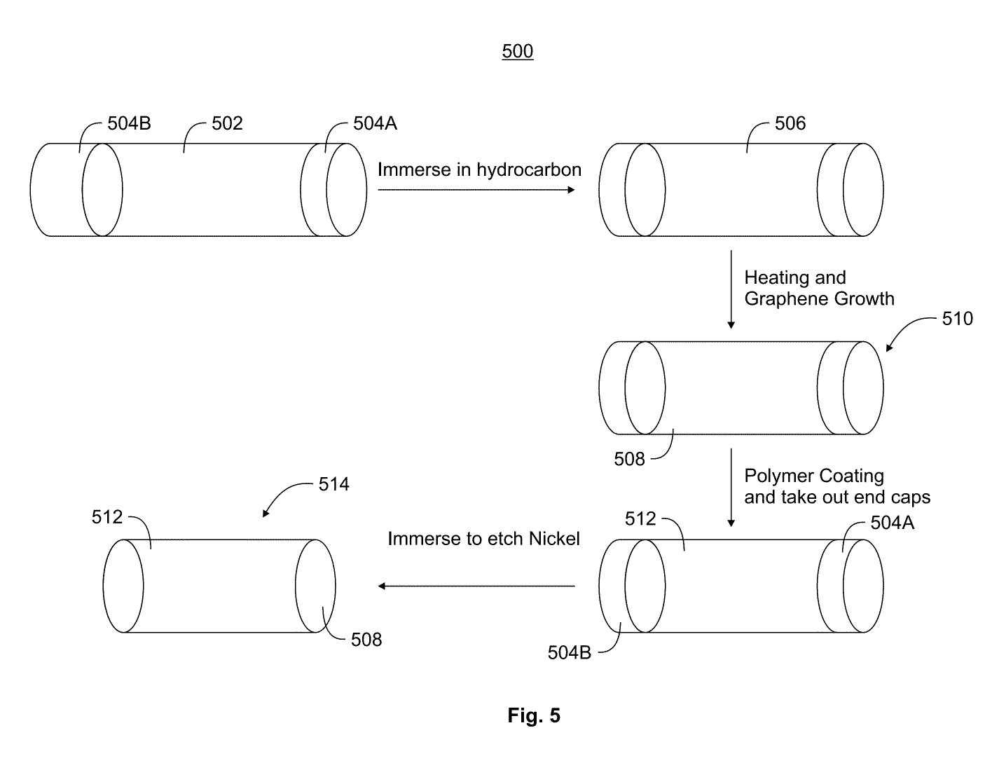

FIG. 5 shows an illustrative process diagram of an exemplary graphene synthesis method 500 to produce tubular graphene membranes. As shown in the schematic of FIG. 5, a substrate 502 in the form of tube can be used. In some embodiments, the substrate 502 may comprise any of the materials (i.e., Ni, Cu, etc.) as herein described. End caps 504A, 504B may be used to close the tube. The method 500 may include a process to coat the tubular substrate 502 with a semi-solid hydrocarbon or semi-solid hydrocarbon mixture 506. In some embodiments, the hydrocarbon 506 includes a semi-solid hydrocarbon or semi-solid saturated hydrocarbon such as paraffin melt, petrolatum, etc., to coat the substrate 502. The method 500 can include a process, such as the heating process described in relation to the method 100, to heat the tubular substrate 502 and precursor 506 undergo thermal decomposition of the precursor at elevated temperatures. As in the method 100, the heating process of the method 500 may result in the fabrication of graphene 508 over the surface of the tubular substrate 502. As in the method 400 of FIG. 4, graphene coated tube 510 can then be dipped, spin coated, or otherwise coated, with a polymer 512 so that the polymer supports the fabricated graphene 508. After this, for example, the ends 504A, 504B of the tube can be opened and then the open-ended tube 514 can be dipped in and etching solution (e.g., FeCl₂, etc.) to etch or dissolve the substrate tube 502 leaving only the graphene 508 in the form of tube supported by the polymer 512. The method 500 can be implemented to produce various layered structures. In some embodiments, various steps of the method 500 may be repeated, thus resulting in multiple layers of graphene (e.g., one layer, five layers, etc.) and a graphene-carbon nanotube hybrid structure.

Exemplary applications of the embodiments described herein include photovoltaic applications, fuel cell applications, catalyst support applications, chemical sensor applications, and others. A multi-layered graphene-carbon nanotube hybrid structure, as described above, may be used in photovoltaic applications. Further, different material quantum dots or metal nanoparticles decorated hybrid structure and different nanostructures can be fabricated on metal nanoparticle embedded graphene films may be used in various other applications.

In some embodiments, for fuel cell applications, exemplary graphene materials of the disclosed technology can be produced to have different dopants that can be used to improve the efficiency and hydrogen storage properties of graphene and its hybrid structure, different nanoparticles that can be used to increase the charging and discharging properties of supercapacitors, and different functionalizations for various applications.

In further embodiments, for catalyst support applications, fabrication of catalyst supported graphene and nitrogen doped catalyst supported graphene can be implemented, e.g., to increase the surface area required for the catalyst for steam methane reforming application.

In still further embodiments, for chemical sensor applications, exemplary graphene materials of the disclosed technology can be functionalized to provide specialized detection of specified analytes.

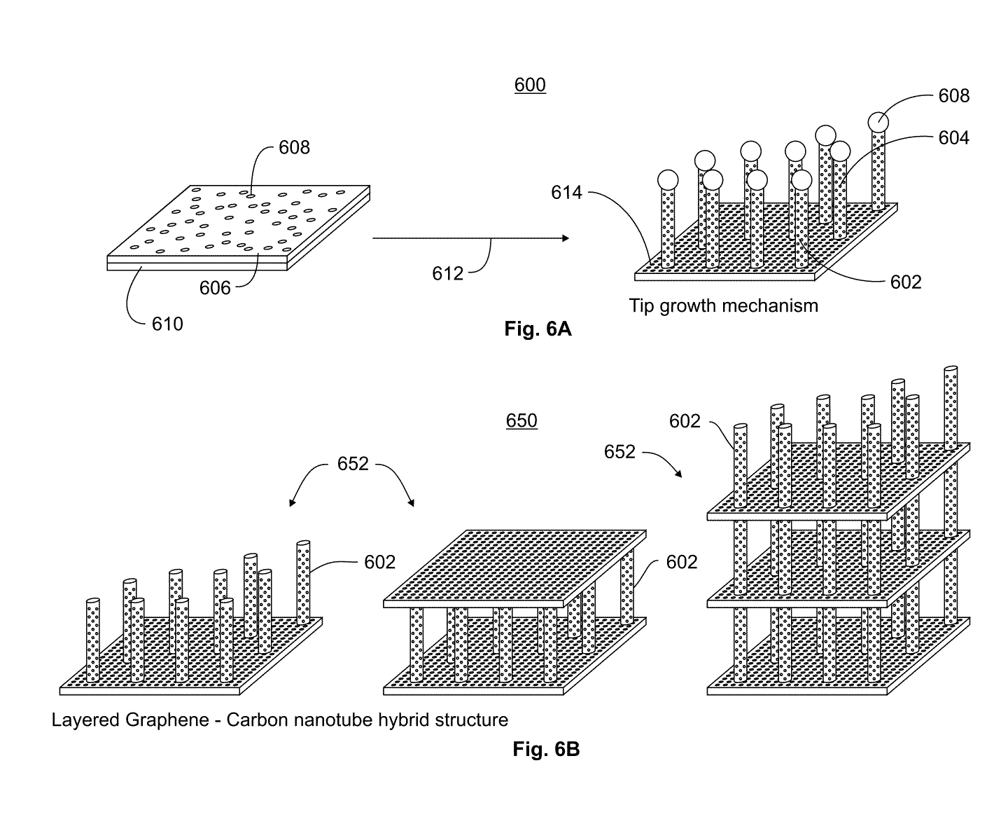

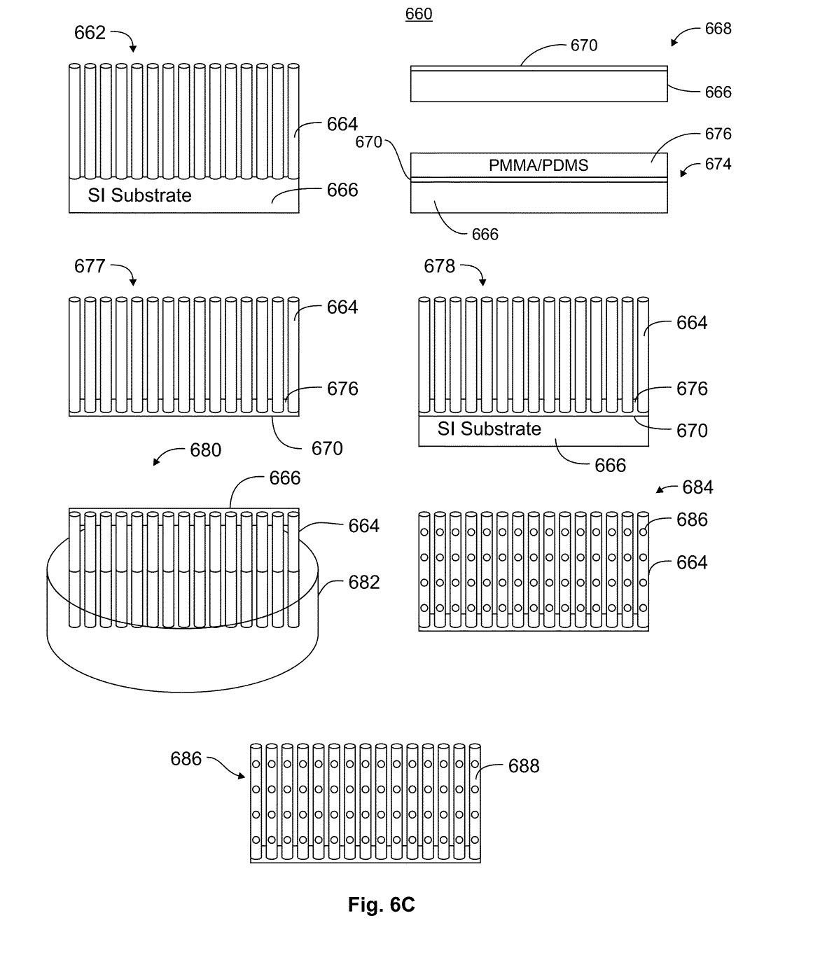

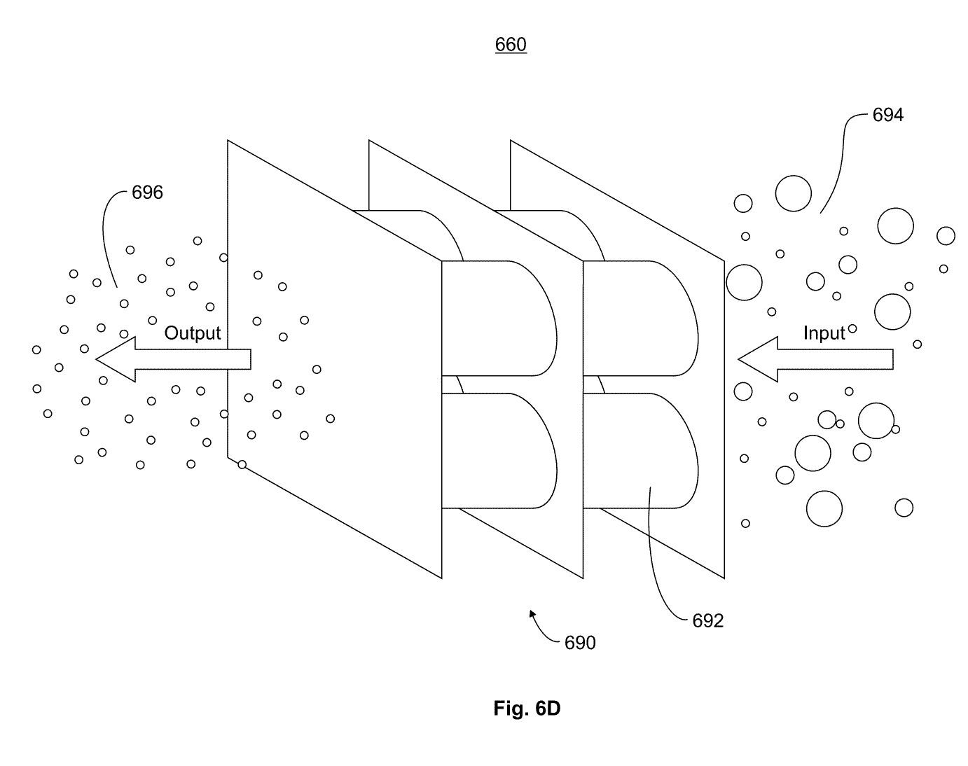

With reference to FIG. 6A and FIG. 6B, in some aspects of the embodiments described herein, fabrication methods include producing vertically aligned carbon nanotubes 602 (VACNTs) with pores 604, where the pores 604 activate the carbon nanotubes.

FIG. 6A shows an illustrative process diagram of an exemplary method 600 for producing a composite material formed of graphene and VACNTs, e.g., which can include porous VACNTs. One exemplary method 600 to produce composite materials including graphene and the VACNTs 602 includes coating a substrate 610 with a precursor material 606 including catalyst nanoparticles 608 embedded in the precursor material 606 on a substrate 610. In some embodiments, the substrate 610 may include a copper foil substrate or a nickel foil substrate, and the material 606 can include metal nanoparticles 608. The metal nanoparticles 608 may be patterned in the coating, e.g., using photolithography and/or etched holes in the substrate 610. Using chemical vapor deposition 612, the method 600 may apply and grow carbon nanotubes 602 over the coated film 614, in which the catalyst nanoparticles 608 are raised on the carbon nanotubes 602. In some embodiments, the nanotubes 602 are Vertically Aligned Single Wall Carbon Nanotubes (VASWCNTs). The method 600 may then remove the substrate 610.

FIG. 6B shows one example of a method 650 for producing a 3D layered graphene composite structure 652 using VACNTs 602. For example, the method 650 may stack the structures produced by the method 600 of FIG. 6A to build the 3D layered graphene composite structure 652.

FIG. 6C shows an illustrative process diagram of an exemplary method 660 to produce porous VACNTs. At 662, the method 660 may grow carbon nanotubes 664 on a substrate 666. In some embodiments, the substrate 666 may include silicon. In other embodiments, the substrate 666 may include aluminum foil. At 668, the method 660 may form graphene 670 on a substrate 666 using a process as generally described at FIGS. 1 and 2. At 674, the method 660 may coat the graphene 670 with a polymer 676. In some embodiments, coating the graphene 670 at 674 may include spin coating a layer of Poly (methyl methacrylate) (PMMA), Poly (dimethylsiloxane) (PDMS), or other polymer 676 onto the graphene 670. At 677, carbon nanotubes 664 may be grown on the substrate 666 as generally described with reference to the method 600 and FIG. 6A. At 680, the carbon nanotubes 664 may be dipped in a solution 682. In some embodiments, the solution 682 may include a basic solution such as potassium hydroxide (KOH). In other embodiments, the solution 682 may include an acidic solution such as hydrogen chloride (HCl) alone or in combination with ferric chloride (FeCl₃). At 684, nanoparticles 684 of the solution 682 may become embedded into the nanotubes 664 as a result of step 680. In some embodiments of step 684, nanoparticles 684 of the substrate 666 (e.g., aluminum) may become embedded into the nanotubes 664 as a result of step 680. The nanoparticles may be sized to about 2 nm and 50 nm. At 686, the nanotubes 664 with embedded nanoparticles 684 of the solution 682 may be heated to evaporate any liquid portion of the solution and then annealed in a gaseous atmosphere to remove the nanoparticles 684 of the solution 682 from the nanotubes 664. In some embodiments, the gas for the annealing step may include argon (e.g., at a flow rate of about 120-150 standard cubic centimeters per minute), or other noble gas. Annealing at 686 may be completed in the absence of any hydrocarbon gas, using argon or other noble gas, or no gas at all. In some embodiments, a gas used in annealing may react with the nanoparticles 682 and result in porous carbon nanotubes 688. In other embodiments, annealing may be completed in the absence of any particular gas, where no gas is used in annealing, and where graphene growth may be completed over a period of about 30 to 45 seconds at a temperature of 900° C. and a pressure of about 300 mTorr.

With reference to FIG. 6D, the various graphene and nanotube structures as described herein may be assembled to create a 3D layered graphene composite structure 690 having VACNTs 692 of identical or varying diameters to provide gas separation of an input gas 694 to separate out one or more gas constituents as the output gas 696. In some embodiments, with reference to the methods 600, 650 of FIGS. 6A and 6B, identical or various sized nanoparticles 608 may be used in the growth processes to create identical or varied diameters of the carbon nanotubes 692, thus allowing the structure 690 to provide separation of identical or various-sized molecules from the input gas 694.

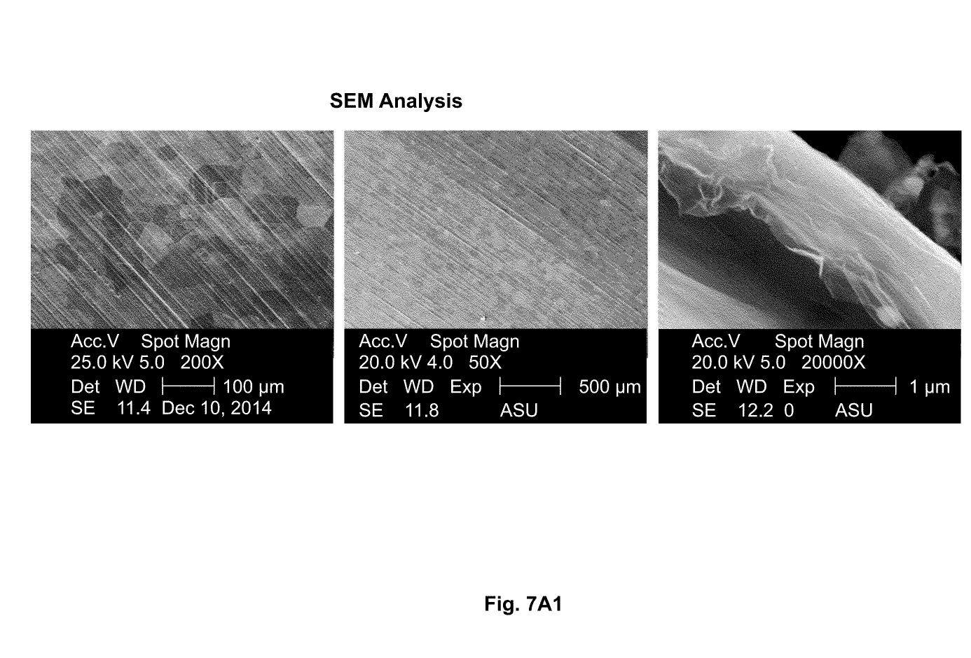

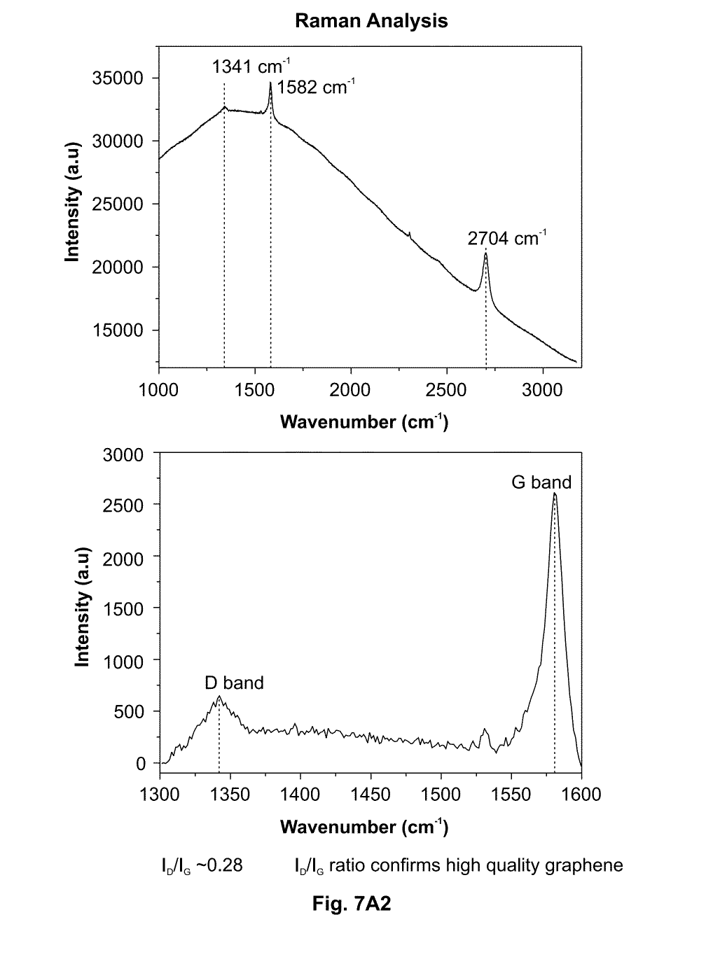

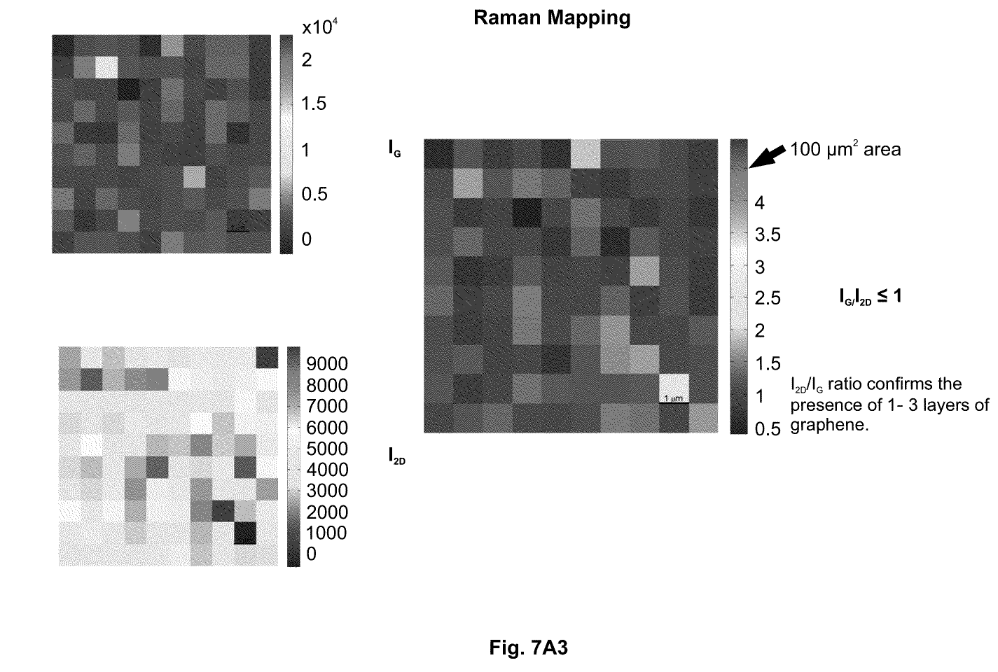

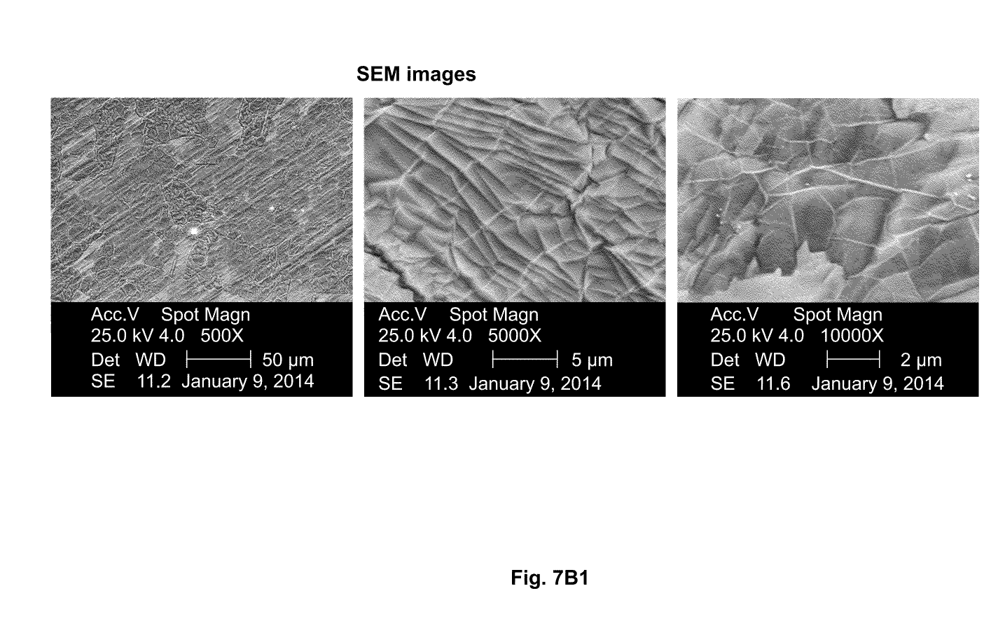

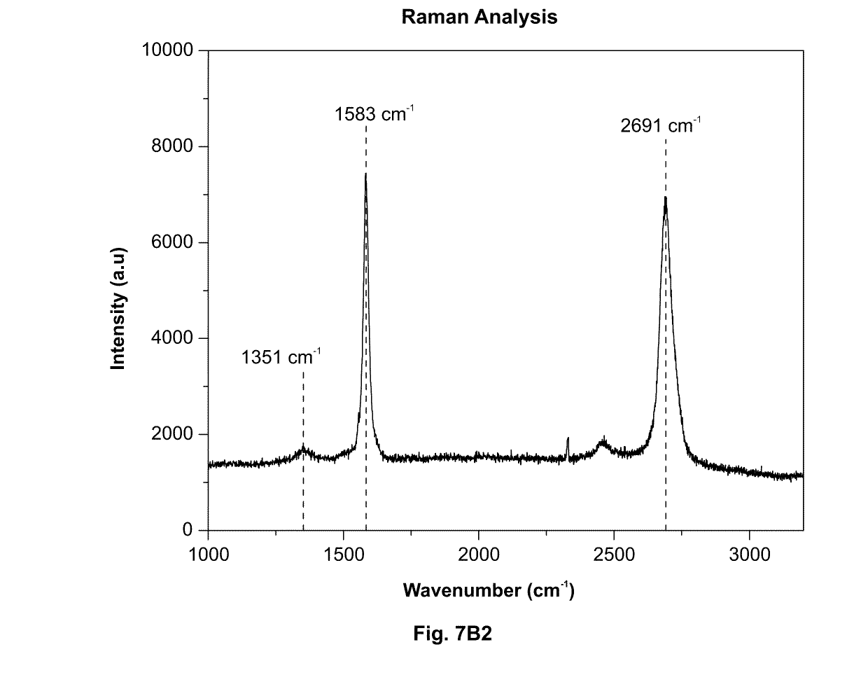

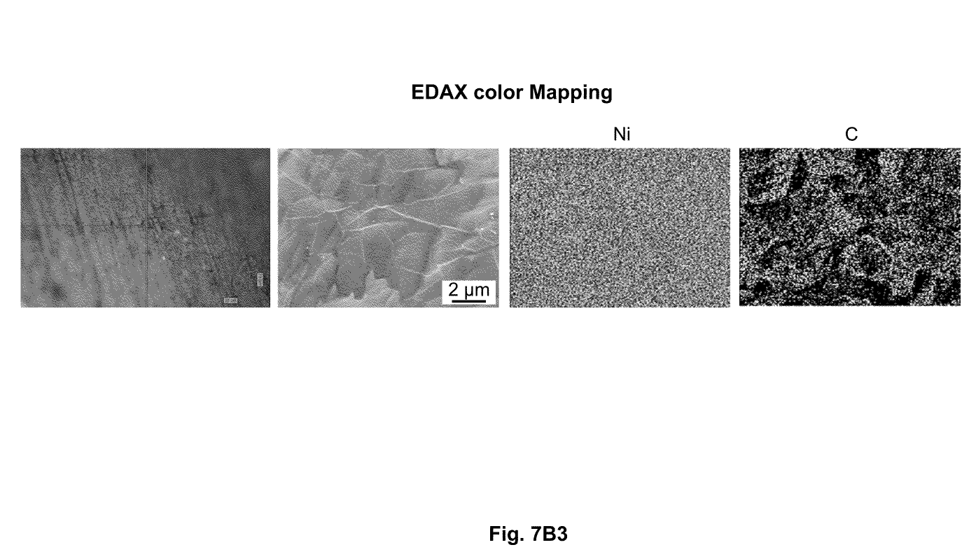

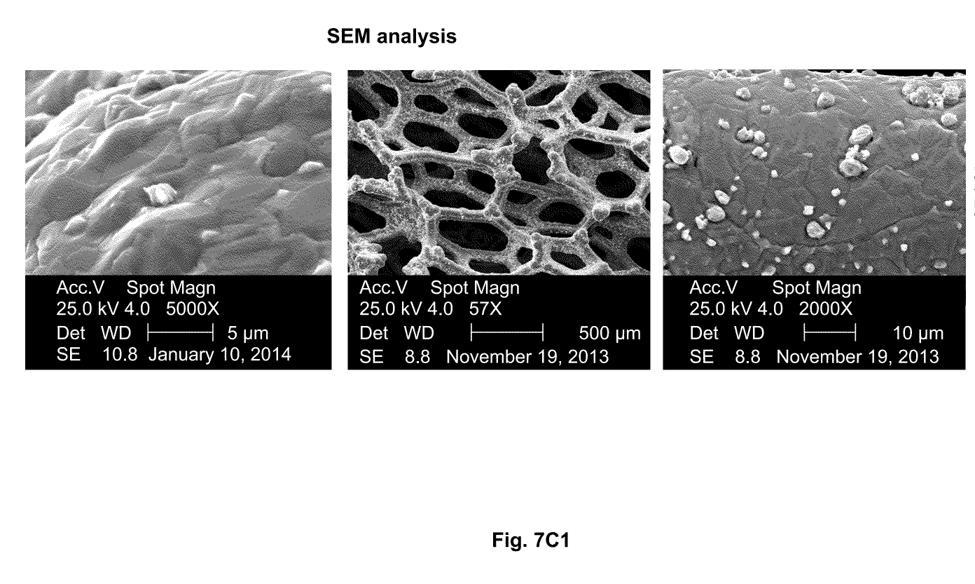

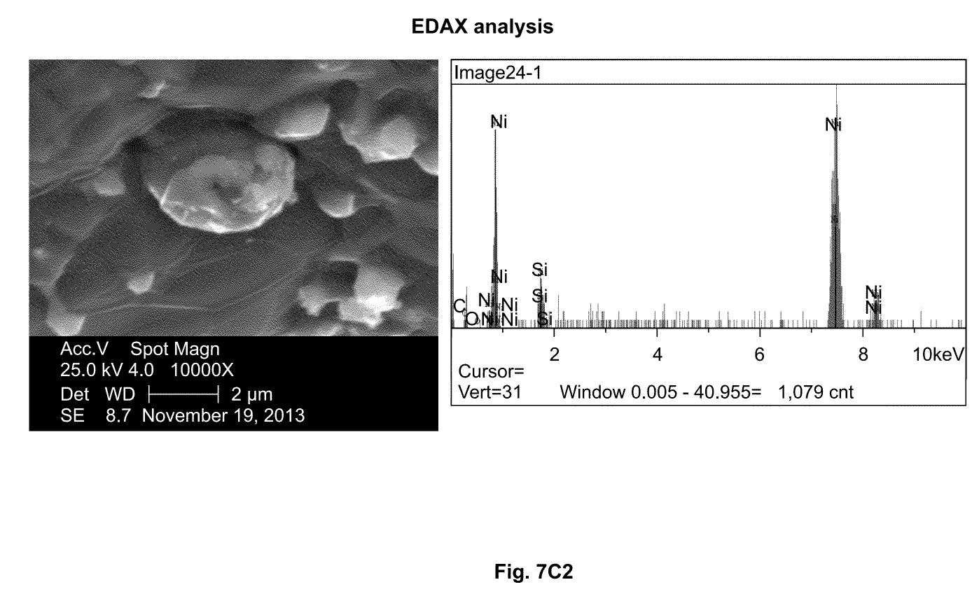

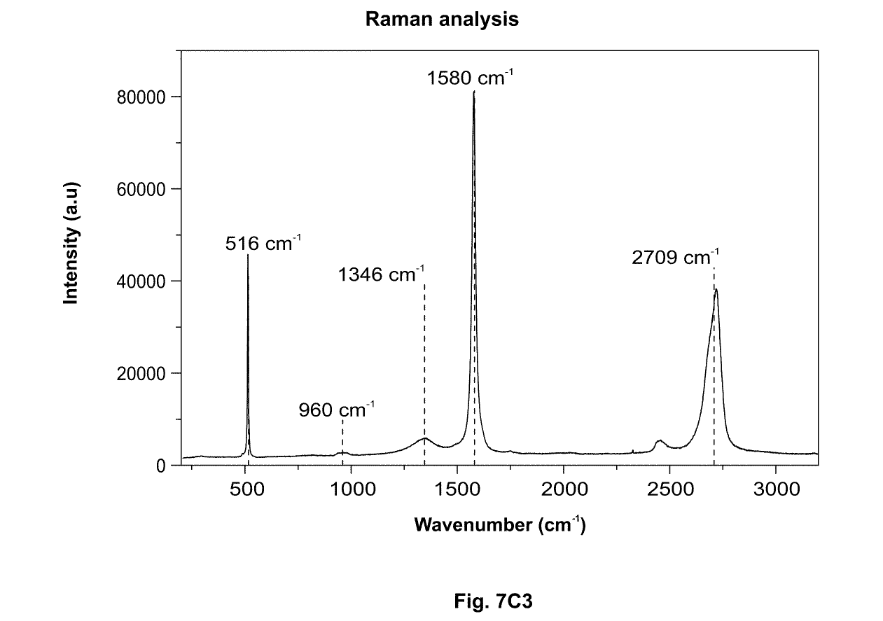

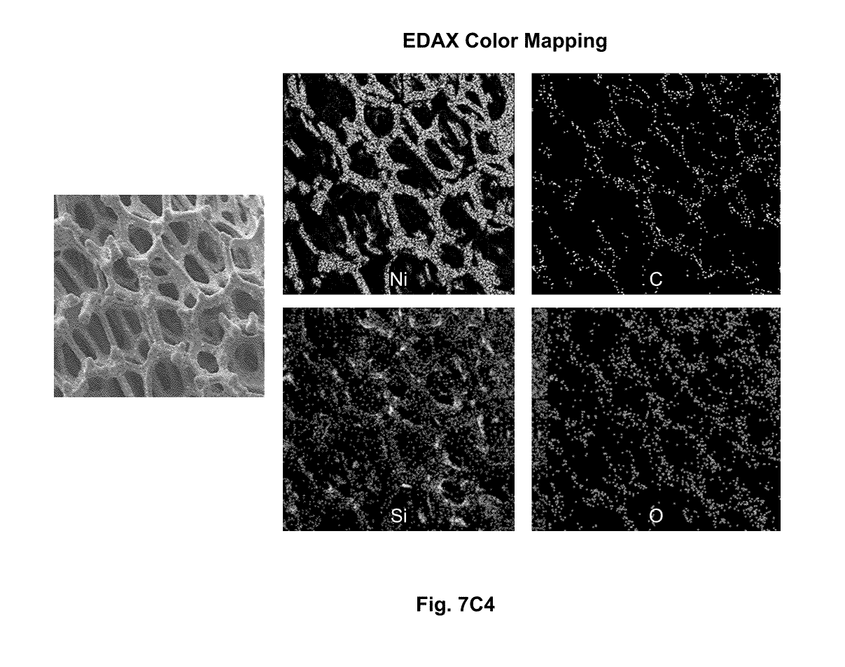

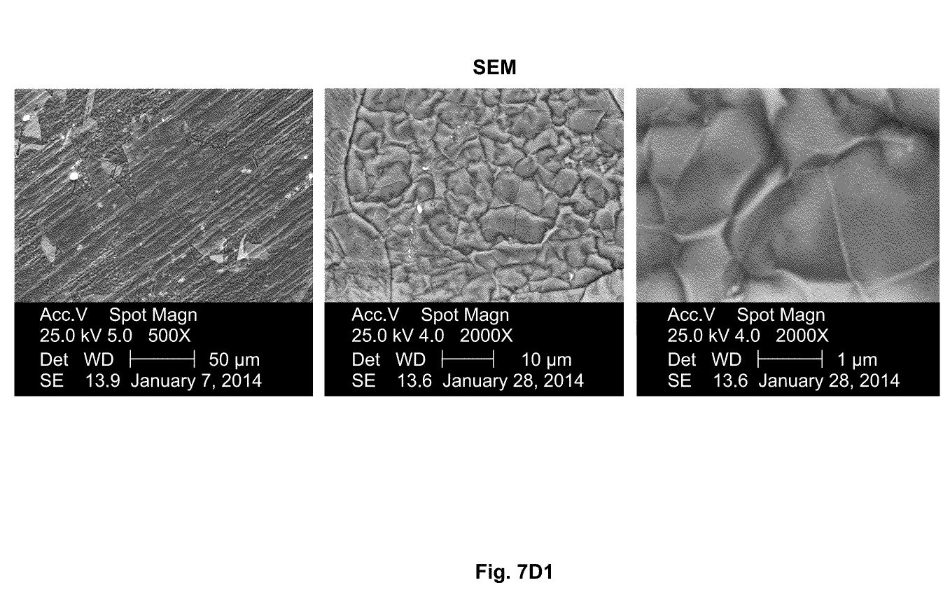

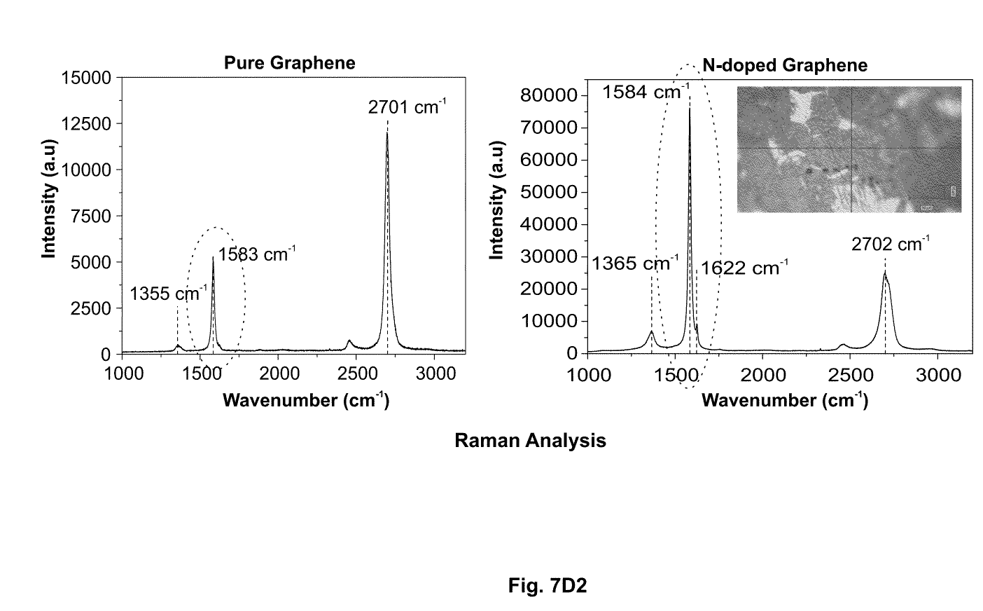

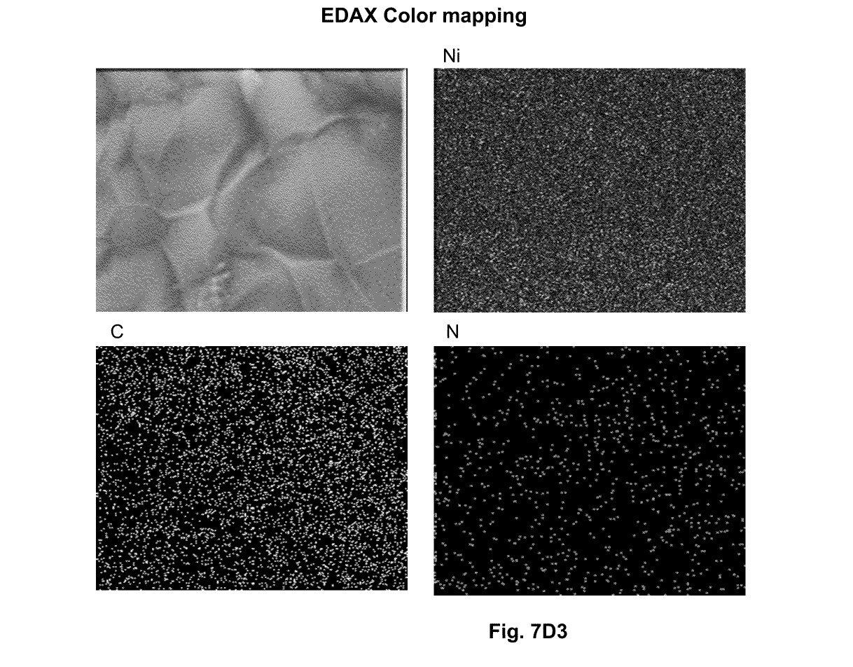

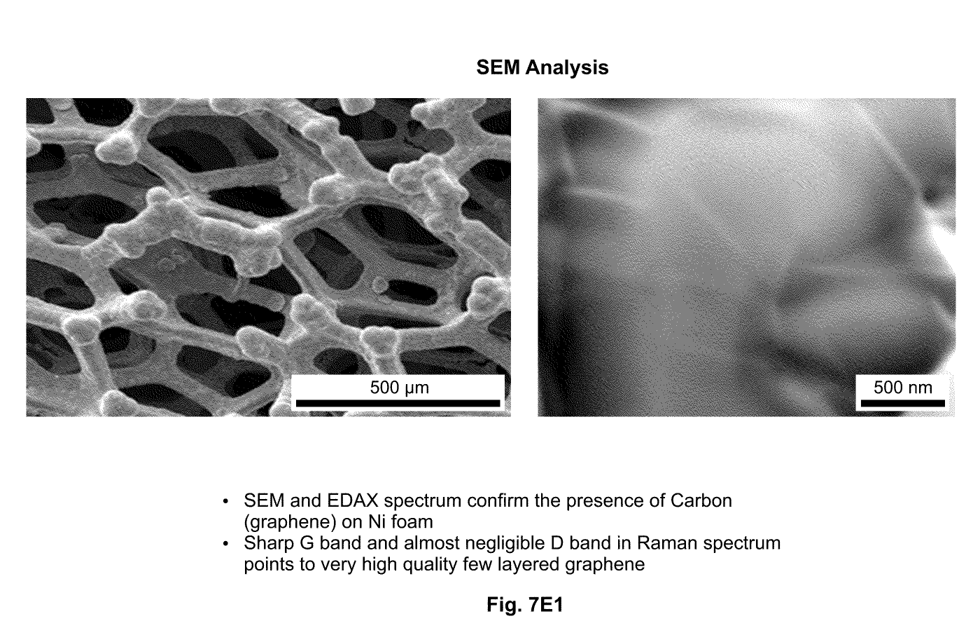

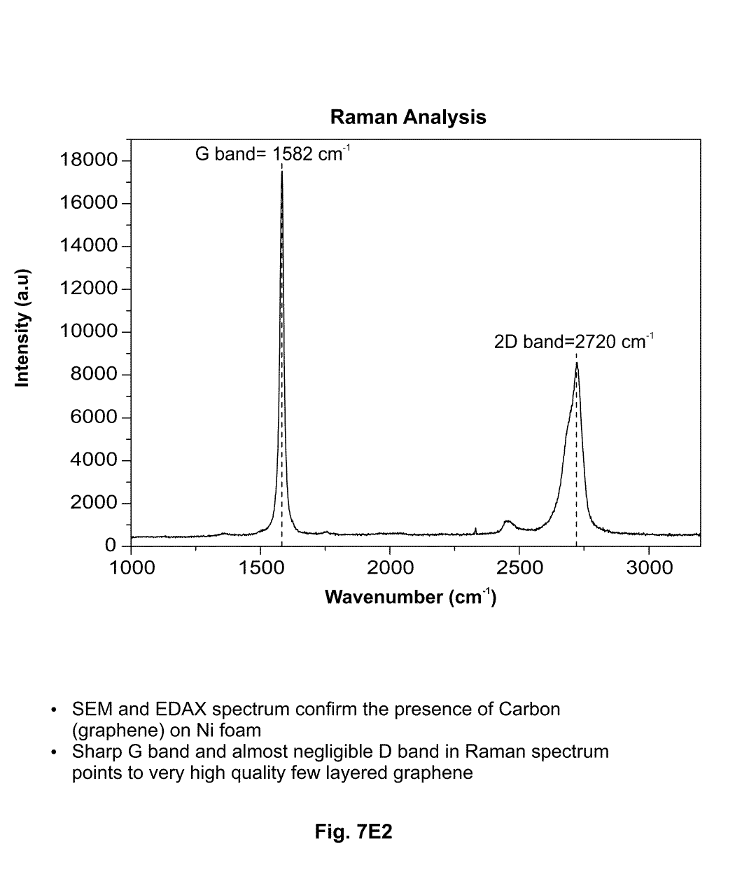

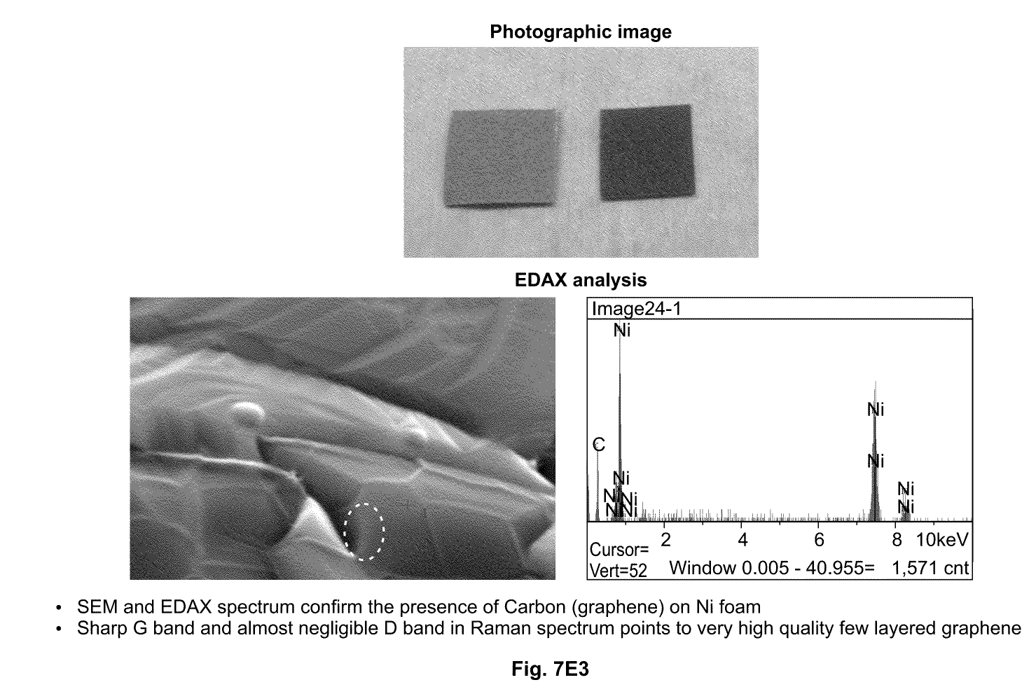

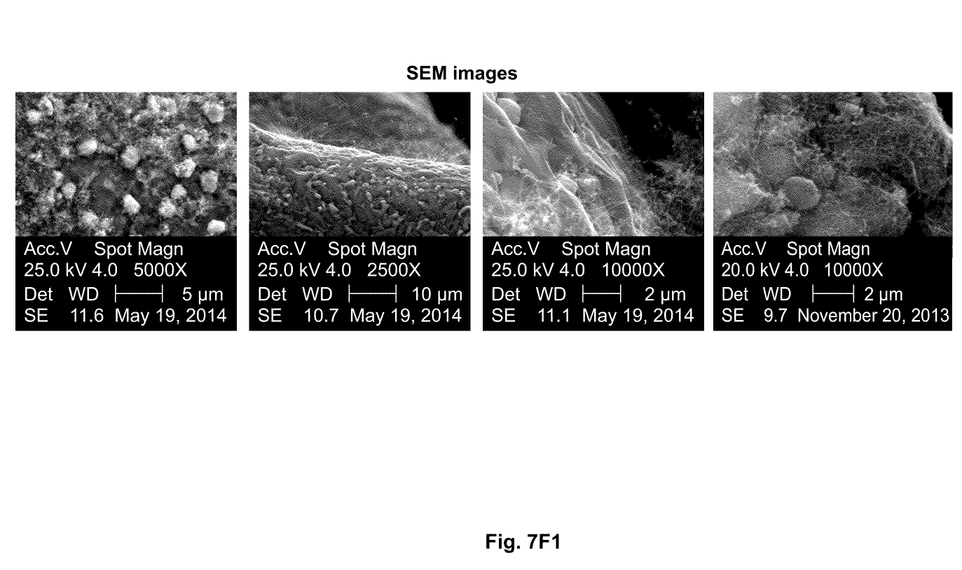

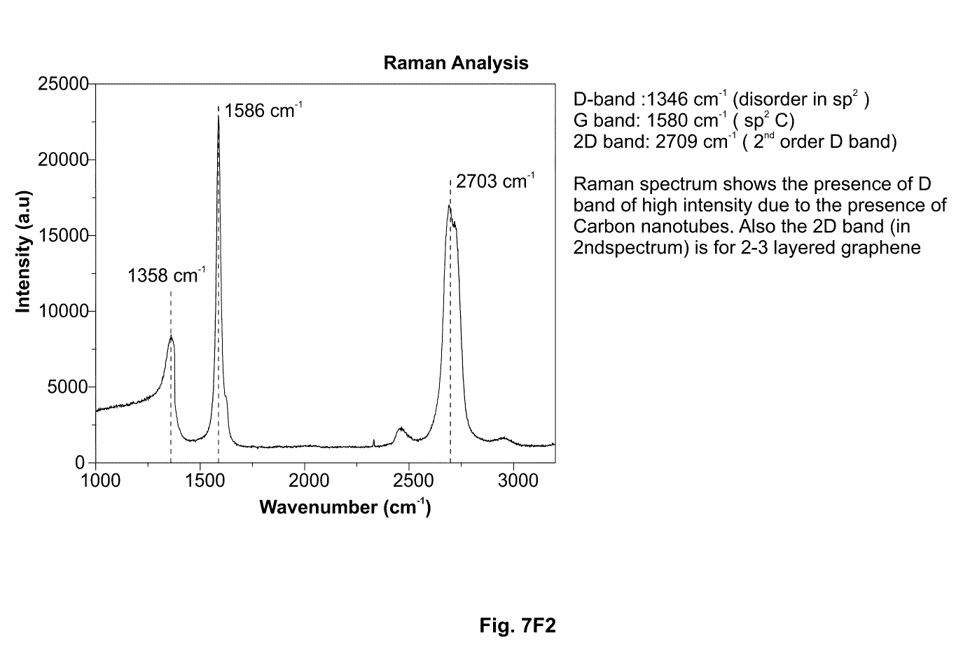

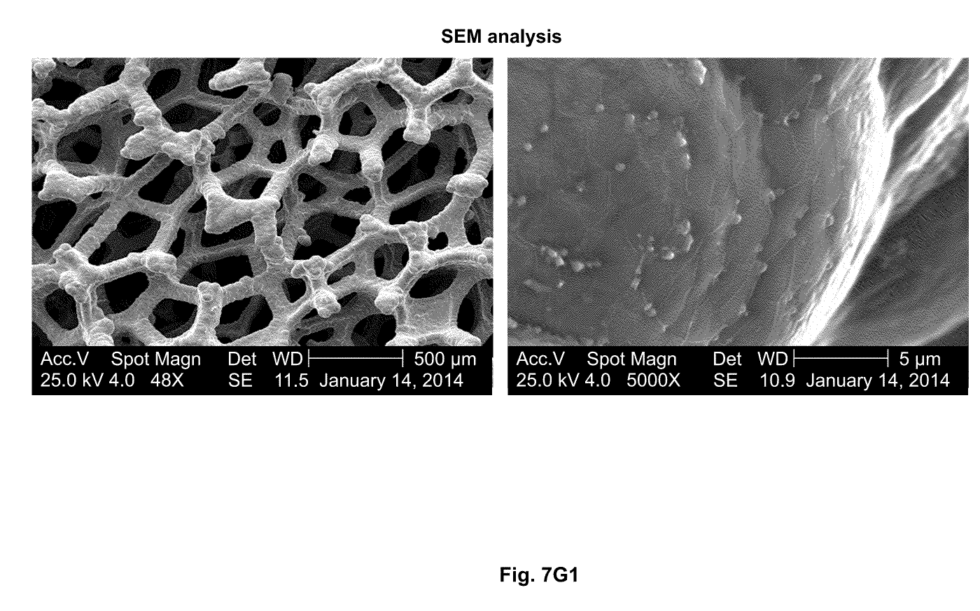

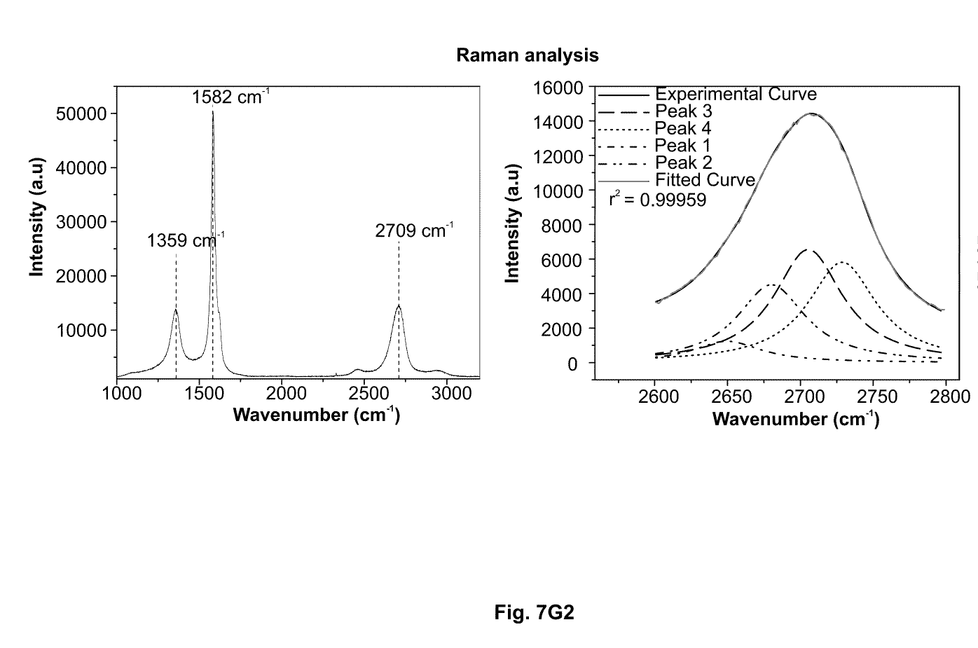

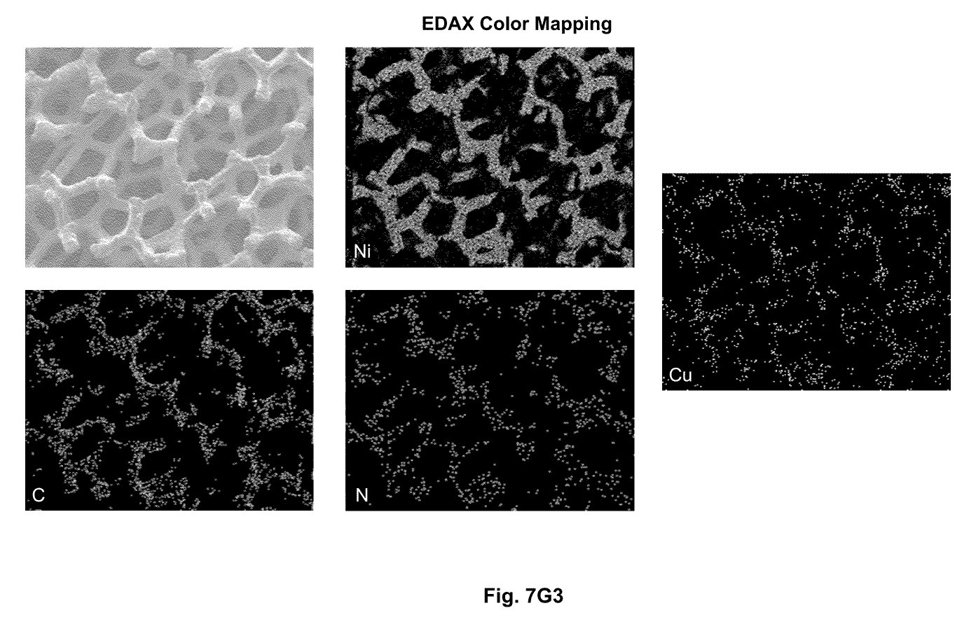

FIGS. 7A1-7F2 show some working examples of the subject matter described herein. These examples are in no way exhaustive of the possible results from the inventions described in this document and represent only some of the results that are possible. These examples illustrate the present inventions and some of its various embodiments and are not intended to limit the scope of the present invention in any way.

FIGS. 7A1-7A3 illustrate a working example of the fabrication of graphene sheets on copper foils. Saturated hydrocarbons n-tetracosane and n-Octacosane may be used. In a typical procedure, 1 g of n-Tetracosane (Alpha Aesar) and 1 g of n-Octacosane (Alpha Aesar) may be mixed and the mixture may be melted on a hot plate for 10 min and heated to a temperature of 120° C. at a rate of 15° C./min. A small portion of this mixture (˜0.05 g) may be transferred on to a copper foil (25 μm-250 μm thick, Alpha Aesar) with the help of a glass dropper and allowed to cool to room temperature at a cooling rate of 15° C./min. The foil may then be placed in a quartz tube. The tube may be pumped down to a base pressure (<5 mTorr) and kept at that pressure for 30 minutes. Then the pressure of the tube may be increased to 500 mTorr from base pressure. The temperature of the reactor may be fixed at 1000° C. and the substrate placed at a temperature in the range of ^{˜}950-1000° C. A pressure in the range of 450-500 mTorr may be used and the sample placed in that condition for a duration of 18 min-45 min. The reactor assembly may then cooled to room temperature at a base pressure of <5 mTorr.

FIGS. 7B1-7B3 illustrate a working example of the fabrication of graphene sheets on Nickel foils. Saturated hydrocarbons n-tetracosane (Alpha Aesar), and n-Octacosane (Alpha Aesar) may be used. In a typical procedure, 1 g of n-tetracosane and 1 g of n-Octacosane may be mixed and melted on a hot plate for 10 min. then heated to a temperature of 120° C. at a rate of 15° C./min. A small portion of this mixture (˜0.05 g) may be transferred on to a nickel foil (25 μm-0.1 mm thick, Alpha Aesar) with the help of a glass dropper and allowed to cool to room temperature at a cooling rate of 15° C./min. The foil may then placed in the quartz tube. The tube may be pumped down to a base pressure (<5 mTorr) and kept at that pressure for 30 minutes. Then the pressure of the tube may be increased to 300 mTorr from base pressure. The temperature of the reactor may be fixed at 900° C. and the substrate placed at a temperature in the range of approximately 800-900° C. A pressure in the range of 250-300 mTorr may be used and the sample placed in that condition for a duration from 15 seconds to 3 minutes. The reactor assembly may then be cooled to room temperature at a base pressure of <5 mTorr

FIGS. 7C1-7C4 may illustrate the fabrication of silicon nanoparticles incorporated graphene. Saturated hydrocarbons, n-tetracosane (Alpha Aesar) and n-octacosane (Alpha Aesar) may be used to fabricate the required precursor material. In a typical procedure, 0.01 g of silicon nanoparticles (Alpha Aesar) may be mixed with 1 g of n-tetracosane and 1 g of n-octacosane and melted on a hot plate by heating the mixture to a temperature of 120° C. at a rate of 15° C./min. A small portion of this mixture (˜0.05 g) may be transferred on to a nickel foam (0.1 mm thick, Alpha Aesar) with the help of a glass dropper and allowed to cool to room temperature at a cooling rate of 15° C./min. The foil may then be placed in a quartz tube. The tube may be pumped down to a base pressure (<5 mTorr) and kept at that pressure for 30 min, then the pressure of the tube may be increased to 300 mTorr from base pressure. The temperature of the reactor may be fixed at 900° C. and the substrate placed at temperature in the range of approximately 800-900° C. A pressure in the range of 250-300 mTorr may be used and the sample placed in that condition for a duration of 15 seconds-3 minutes. The reactor assembly may then be cooled to room temperature at a base pressure of <5 mTorr.

FIGS. 7D1, 7D2, and 7D3 may illustrate a working example of the fabrication of Nitrogen doped graphene. Saturated hydrocarbons, n-tetracosane (Alpha Aesar) and n-octacosane (Alpha Aesar) may be used to fabricate the required material. In a typical procedure, 0.01 g of Phthalocyanine (Alpha Aesar) may be mixed with 1 g of n-tetracosane and 1 g of n-octacosane and melted on a hot plate by heating the mixture to a temperature of 120° C. at a rate of 15° C./min. A small portion of this mixture (˜0.05 g) may be transferred on to a nickel foil (25 μm-0.1 mm thick, Alpha Aesar) with the help of a glass dropper and allowed to cool to room temperature at a cooling rate of 15° C./min. The foil may then be placed in the quartz tube. The tube may be pumped down to a base pressure (<5 mTorr) and kept at that pressure for 30 minutes. Then the pressure of the tube may be increased to 300 mTorr from base pressure. The temperature of the reactor may be fixed at 900° C. and the substrate placed at temperature in the range of approximately 800-900° C. A pressure in the range of 250-300 mTorr may be used and the sample placed in that condition for a duration of 15 s-3 min. The reactor assembly may then be cooled to room temperature at a base pressure of <5 mTorr.

FIGS. 7E1, 7E2, and 7E3 may illustrate a working example of graphene coated nickel foam (3D structure). Saturated hydrocarbons, n-tetracosane (Alpha Aesar) and n-octacosane (Alpha Aesar) may be used to fabricate the required material. In a typical procedure, 1 g of n-tetracosane and 1 g of n-octacosane may be mixed and melted on a hot plate by heating the mixture to a temperature of 120° C. at a rate of 15° C./min. A small portion of this mixture (˜0.05 g) may be transferred on to a 0.1 mm thick nickel foam (Alpha Aesar) with the help of a glass dropper and was allowed to cool to room temperature at a cooling rate of 15° C./min. The foil may then be placed in the quartz tube. The tube may be pumped down to a base pressure (<5 mTorr) and kept at that pressure for 30 minutes. Then the pressure of the tube may be increased to 300 mTorr from base pressure. The temperature of the reactor may be fixed at 900° C. and the substrate placed at temperature in the range of ^{˜}800-900° C. A pressure in the range of 250-300 mTorr may be used and the sample placed in that condition for a duration from 15 s-3 min. The reactor assembly may then be cooled to room temperature at a base pressure of <5 mTorr.

FIGS. 7F1 and 7F2 may illustrate a working example of the fabrication of a nanostructure-graphene hybrid in general and, particularly, a CNT-graphene hybrid structure. Saturated hydrocarbons, n-tetracosane (Alpha Aesar) and n-octacosane (Alpha Aesar) may be used to fabricate the required material. In a typical procedure, 0.01 g of commercially available carbon nanotubes (Nanostructured and Amorphous Materials Inc.) may be mixed with 1 g of n-tetracosane and 1 g of n-octacosane and melted on a hot plate by heating the mixture to a temperature of 120° C. at a rate of 15° C./min. A small portion of this mixture (˜0.05 g) may be transferred on to a nickel foam (0.1 mm thick, Alpha Aesar) with the help of a glass dropper and allowed to cool to room temperature at a cooling rate of 15° C./min. The foil may then be placed in the quartz tube. The tube may be pumped down to a base pressure (<5 mTorr) and kept at that pressure for 30 minutes. Then the pressure of the tube may be increased to 300 mTorr from base pressure. The temperature of the reactor may be fixed at 900° C. and the substrate placed at a temperature in the range of ^{˜}800-900° C. A pressure in the range of 250-300 mTorr may be used and the sample may be placed in that condition for a duration of 15 s-3 min. The reactor assembly may then be cooled to room temperature at a base pressure of <5 mTorr.

FIGS. 7G1, 7G2, and 7G3 illustrate a working example of the fabrication of Nitrogen doped graphene with metal nanoparticles incorporation. Saturated hydrocarbons, n-tetracosane (Alpha Aesar) and n-octacosane (Alpha Aesar) may be used to fabricate the required material. In a typical procedure, 0.01 g of copper phthalocyanine (Alpha Aesar) may be mixed with 1 g of n-tetracosane and 1 g of n-octacosane and melted on a hot plate by heating the mixture to a temperature of 120° C. at a rate of 15° C./min. A small portion of this mixture (˜0.05 g) may be transferred on to a nickel foam (0.1 mm thick, Alpha Aesar) with the help of a glass dropper and allowed to cool to room temperature at a cooling rate of 15° C./min. The foil may then be placed in the quartz tube. The tube may be pumped down to a base pressure (<5 mTorr) and kept at that pressure for 30 minutes. Then the pressure of the tube may be increased to 300 mTorr from base pressure. The temperature of the reactor may be fixed at 900° C. and the substrate placed at a temperature in the range of ^{˜}800-900° C. A pressure in the range of 250-300 mTorr may be used and the sample placed in that condition for a duration from 15 s-3 min. The reactor assembly may then be cooled to room temperature at a base pressure of <5 mTorr.

While this document describes various embodiments, the described embodiments should not be construed as limitations on the scope of any invention or of what may be claimed, but rather as descriptions of features that may be specific to particular embodiments of particular inventions. For example, any of the elements of the embodiments described herein may be combined with any of the other embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this document should not be understood as requiring such separation in all embodiments.

Only a few implementations and examples are described and other implementations, enhancements and variations can be made based on what is described and illustrated in this document.

While the disclosure has been described in detail and with reference to specific embodiments thereof, it will be apparent to one skilled in the art that various changes and modifications can be made therein without departing from the spirit and scope of the claims. Thus, it is intended that the present disclosure cover the modifications and variations of this disclosure and their equivalents.

1. A method for fabricating graphene materials, comprising:
coating a semi-solid hydrocarbon precursor onto a metal substrate;
heating the semi-solid hydrocarbon precursor and the coated metal substrate to a first temperature;
maintaining the first temperature to dissociate the semi-solid hydrocarbon precursor into carbon on the metal substrate; and
cooling to a second temperature that is lower than the first temperature to allow the dissociated hydrocarbon to arrange itself into graphene on the metal substrate.

2. The method of claim 1, wherein at least a portion of the semi-solid hydrocarbon precursor is petrolatum.

3. The method of claim 1, wherein at least a portion of the semi-solid hydrocarbon is paraffin melt.

4. The method of claim 1, wherein the metal substrate includes at least one of nickel, copper, or a stainless steel.

5. The method of claim 4, wherein the metal substrate includes one or more of a foil, a foam, a sheet, and a deposited layer.

6. The method of claim 5, wherein the metal substrate is substantially tubular.

7. The method of claim 1, further comprising pre-annealing the metal substrate before applying the hydrocarbon.

8. The method of claim 1, wherein heating the coated metal substrate includes heating the coated metal substrate within a chamber.

9. The method of claim 1, wherein at least a portion of the semi-solid hydrocarbon is petroleum jelly.

10. The method of claim 1, wherein the semi-solid hydrocarbon precursor includes a nitrogenous compound.

11. The method of claim 10, wherein the nitrogenous compound includes one or more of pyridine, phthalocyanine, and pyrazole.

12. The method of claim 1, wherein the semi-solid hydrocarbon precursor includes nanoparticles of at least one of a metal, a metalloid, or a semiconductor.

13. The method of claim 12, wherein the metal nanoparticles include at least one of nickel, copper, iron, gold, silver, platinum, palladium, cobalt, iridium, rhodium, osmium, and ruthenium.

14. A method for producing porous graphene comprising:
coating a semi-solid hydrocarbon-nanoparticle mixture onto a metal substrate, the hydrocarbon-nanoparticle mixture including a saturated hydrocarbon and nanoparticles;
heating the semi-solid hydrocarbon-nanoparticle mixture coated metal substrate to substantially at least 450° C.;
maintaining a temperature of the semi-solid hydrocarbon-nanoparticle mixture coated metal substrate at substantially at least 450° C. to dissociate the semi-solid hydrocarbon-nanoparticle mixture on the surface of the metal substrate into carbon and the nanoparticles; and
cooling the heated semi-solid hydrocarbon-nanoparticle mixture coated metal substrate by substantially at least 20° C. per minute to reach 200° C. or less, wherein the cooling allows the carbon to precipitate out at the surface of the metal substrate and arrange itself into graphene together with the nanoparticles;
coating a polymer on the graphene and nanoparticles; and
dispersing the metal substrate and nanoparticles.

15. The method of claim 14, wherein the polymer includes one or more of poly (methyl methacrylate) (PMMA) or poly (dimethylsiloxane) (PDMS).

16. The method of claim 14, wherein the metal substrate is substantially tubular.

17. The method of claim 16, wherein dispersing the metal substrate and nanoparticles includes immersing the polymer coated graphene and nanoparticles in a chemical solution.

18. The method of claim 17, wherein the chemical solution is strongly basic or strongly acidic.

19. The method of claim 18, wherein the strongly basic solution is potassium hydroxide (KOH) and the strongly acidic solution is hydrogen chloride (HCl) alone or in combination with ferric chloride (FeCl₃).

20. The method of claim 14, wherein the nanoparticles include at least one of copper, nickel, activated carbon, silicon, zinc oxide, tin oxide, or manganese oxide.
